(19) United States
(12) Patent Application Publication
(10) Pub. No.: US 2025/0029775 A1
(43) Pub. Date: Jan. 23, 2025

(54) INTERLEAVED COUPLED INDUCTORS TRANSFORMER

(71) Applicants: STMICROELECTRONICS INTERNATIONAL N.V, Geneva (CH); CENTRE NATIONAL DE LA RECHERCHE SCIENTIFIQUE, Paris (FR); INSTITUT POLYTECHNIQUE DE BORDEAUX, Talence (FR); UNIVERSITE DE BORDEAUX, Bordeaux (FR)

(72) Inventors: Sebastien SADLO, Paris (FR); Nathalie DELTIMPLE, Pessac (FR); Andreia CATHELIN, Laval (FR)

(21) Appl. No.: 18/354,945

(22) Filed: Jul. 19, 2023

(51) Int. Cl. H01F 27/28; H01F 27/29; H01F 37/00

(52) U.S. Cl. CPC H01F 27/2852; H01F 27/29; H01F 37/00

(57) ABSTRACT

An interleaved coupled inductors transformer is described in accordance with various embodiments of the present disclosure. In various embodiments, the interleaved coupled inductors transformer includes a first terminal including a first port, a first branch of the first terminal, and a second branch of the first terminal approximately parallel to with the first branch of the first terminal. The interleaved coupled inductors transformer includes a second terminal spatially separate from the first terminal, the second terminal including a second port, a first branch of the second terminal, a second branch of the second terminal approximately parallel to with the first branch of the second terminal, wherein the first and second branches of the first terminal do not overlap with the first and second branches of the second terminal.

Example embodiments of the present disclosure relate generally to the field of transformers and in particular coupled inductors transformers, for example as used in high frequency integrated circuits.

### BACKGROUND

Coupled inductors transformers are used in electronic circuits such as silicon based Integrated Circuits (ICs) for power transfer, power splitting and/or combining, impedance matching, etc. Applicant has identified many technical challenges and difficulties associated with coupled inductors transformers. Through applied effort, ingenuity, and innovation, Applicant has solved problems related to transformers, which are described in detail below.

### BRIEF SUMMARY

An interleaved coupled inductors transformer is provided in accordance with various embodiments of the present disclosure. In various embodiments, the interleaved coupled inductors transformer includes a first terminal including a first port, a first branch of the first terminal, and a second branch of the first terminal approximately parallel to and concentric with the first branch of the first terminal. The interleaved coupled inductors transformer includes a second terminal spatially separate from the first terminal, the second terminal including a second port, a first branch of the second terminal, a second branch of the second terminal approximately parallel to and concentric with the first branch of the second terminal, wherein the first and second branches of the first terminal do not overlap with the first and second branches of the second terminal.

In various embodiments, the first and second branches of the first terminal are in a same first plane and the first and second branches of the second terminal are in a same second plane. In various embodiments, the first and second branches of the first terminal are made using a first conductive layer of a three-dimensional integrated circuit and the first and second branches of the second terminal are made using a second conductive layer of the three-dimensional integrated circuit.

In various embodiments, each of the first and second branches of the first terminal and the first and second branches of the second terminal are in a different corresponding plane.

In various embodiments, the first branch of the first terminal is made using a first conductive layer of a three-dimensional integrated circuit and the second branch of the first terminal is made using a second conductive layer of the three-dimensional integrated circuit, or wherein the first branch of the second terminal is made using a third conductive layer of the three-dimensional integrated circuit and the second branch of the second terminal is made using a fourth conductive layer of the three-dimensional integrated circuit.

In various embodiments, the first conductive layer and the second conductive layer of the three-dimensional integrated circuit are electrically coupled by a first via or the third conductive layer and the fourth conductive layer of the three-dimensional integrated circuit are electrically coupled by a second via. In various embodiments, the first conductive layer and the second conductive layer are both positioned in a same side of the second conductive layer and the third conductive layer.

In various embodiments, the third conductive layer is sandwiched between the first and second conductive layers and the second conductive layer is sandwiched between the third and fourth conductive layers.

In various embodiments, a length of the first and second branches of the first terminal is approximately equal to a length of the first and second branches of the second terminal.

In various embodiments, an impedance of the first terminal is approximately the same as an impedance of the second terminal.

In various embodiments, the first and second branches of the first terminal and the first and second branches of the second terminal are approximately concentric.

In various embodiments, the first terminal includes: a first pin of the first port, a second pin of the first port, and a first DC feed electronically coupled to a middle point from the first pin of the first port to the second pin of the first port, the first DC feed configured to provide a first bias voltage to the first terminal, or the second terminal includes: a first pin of the second port, a second pin of the second port, and a second DC feed electronically coupled to a middle point from the first pin of the second port to the second pin of the second port, the second DC feed configured to provide a second bias voltage to the second terminal.

In various embodiments, the first terminal has a same number of branches as the second terminal.

In various embodiments, the first terminal includes at least a third branch of the first terminal approximately parallel to and concentric with the first branch of the first terminal and with the second branch of the first terminal, and the second terminal comprising at least a third branch of the second terminal approximately parallel to and concentric with the first branch of the second terminal and with the second branch of the second terminal, wherein the first, second, and the at least third branches of the first terminal do not overlap with the first, second, and the at least third branches of the second terminal.

In various embodiments, the interleaved coupled inductors transformer includes at least a third terminal spatially separate from the first terminal and the second terminal, the at least third terminal includes a third port, a first branch of the at least third terminal, and a second branch of the at least third terminal approximately parallel to and concentric with the first branch of the at least third terminal, wherein the first and second branches of the at least third terminal do not overlap with the first and second branches of the first terminal or with the first and second branches of the second terminal.

In various embodiments, the interleaved coupled inductors transformer includes at least a third terminal spatially separate from the first terminal and the second terminal, the at least third terminal includes a third port, a first branch of the at least third terminal, and a second branch of the at least third terminal approximately parallel to and concentric with the first branch of the at least third terminal, wherein the first and second branches of the at least third terminal do not overlap with the first and second branches of the first terminal and with the first and second branches of the second terminal.

In various embodiments, an interleaved coupled inductors transformer includes: a first terminal includes: a first port, a first branch of the first terminal, and a second branch of the first terminal. In various embodiments, the interleaved coupled inductors transformer includes: a second terminal spatially separate from the first terminal, the second terminal includes: a second port, a first branch of the second terminal, a second branch of the second terminal, wherein the first and second branches of the first terminal do not overlap with the first and second branches of the second terminal, and wherein the first and second branches of the first terminal are concentric with the first and second branches of the second terminal.

In various embodiments, an interleaved coupled inductors transformer includes: a first terminal includes: a first port, a first branch of the first terminal, and a second branch of the first terminal, and a second terminal spatially separate from the first terminal, the second terminal includes: a second port, a first branch of the second terminal, a second branch of the second terminal, wherein the first and second branches of the first terminal do not overlap with the first and second branches of the second terminal, and wherein the first and second branches of the first terminal are off centered with respect to the first and second branches of the second terminal such that an impedance of the first terminal is equal to an impedance of the second terminal.

In various embodiments, the first and second branches of the first terminal are in a same first plane and the first and second branches of the second terminal are in a same second plane and wherein the first and second branches of the first terminal are made using a first conductive layer of a three-dimensional integrated circuit and the first and second branches of the second terminal are made using a second conductive layer of a second conductive layer of the three-dimensional integrated circuit.

In various embodiments, each of the first and second branches of the first terminal and the first and second branches of the second terminal are in a different corresponding plane and wherein the first branch of the first terminal is made using a first conductive layer of a three-dimensional integrated circuit and the second branch of the first terminal is made using a second conductive layer of the three-dimensional integrated circuit, or wherein the first branch of the second terminal is made using a third conductive layer of the three-dimensional integrated circuit and the second branch of the second terminal is made using a fourth conductive layer of the three-dimensional integrated circuit.

In various embodiments, the first conductive layer and the second conductive layer are both positioned in a same side of the second conductive layer and the third conductive layer.

In various embodiments, the third conductive layer is sandwiched between the first and second conductive layers and the second conductive layer is sandwiched between the third and fourth conductive layers.

In various embodiments, the first terminal includes: a first pin of the first port, a second pin of the first port, and a first DC feed electronically coupled to a middle point from the first pin of the first port to the second pin of the first port, the first DC feed configured to provide a first bias voltage to the first terminal, or the second terminal includes: a first pin of the second port, a second pin of the second port, and a second DC feed electronically coupled to a middle point from the first pin of the second port to the second pin of the second port, the second DC feed configured to provide a second bias voltage to the second terminal.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will also be appreciated that the scope of the disclosure encompasses many potential embodiments in addition to those here summarized, some of which will be further described below.

### BRIEF DESCRIPTION OF THE SEVERAL VIEWS OF THE DRAWINGS

The description of the illustrative embodiments may be read in conjunction with the accompanying figures. It will be appreciated that, for simplicity and clarity of illustration, elements illustrated in the figures have not necessarily been drawn to scale, unless described otherwise. For example, the dimensions of some of the elements may be exaggerated relative to other elements, unless described otherwise. Embodiments incorporating teachings of the present disclosure are shown and described with respect to the figures presented herein, in which:

FIG. 1 is a schematic diagram illustrating a coupled inductors transformer.

FIG. 2 is a schematic diagram illustrating a coupled inductors transformer.

FIG. 3 is a schematic diagram illustrating an interleaved coupled inductors transformer in accordance with various embodiments of the present disclosure.

FIG. 4A is a diagram illustrating a coupled inductors transformer and a performance measurement or simulation.

FIG. 4B is a diagram illustrating an interleaved coupled inductors transformer and a performance measurement or simulation in accordance with various embodiments of the present disclosure.

FIG. 5 is a schematic diagram illustrating an interleaved coupled inductors transformer in accordance with various embodiments of the present disclosure.

FIG. 6 is a schematic diagram illustrating an interleaved coupled inductors transformer in accordance with various embodiments of the present disclosure.

FIG. 7A is a schematic diagram illustrating an interleaved coupled inductors transformer in accordance with various embodiments of the present disclosure.

FIG. 7B is a schematic diagram illustrating an interleaved coupled inductors transformer in accordance with various embodiments of the present disclosure.

### DETAILED DESCRIPTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

The components illustrated in the figures represent components that may or may not be present in various embodiments of the present disclosure described herein such that embodiments may include fewer or more components than those shown in the figures while not departing from the scope of the present disclosure. Some components/aspects may be omitted from one or more figures or shown in dashed line for visibility, clarity, and/or illustrative purposes, for example for visibility of the underlying components.

The phrases “in an example embodiment,” “some embodiments,” “various embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such components or features may be optionally included in some embodiments, or may be excluded.

The terms “electronically coupled” in the present disclosure refer to two or more electrical elements and/or electric circuit(s) being connected through wired means (for example but not limited to, conductive wires or traces) and/or wireless means (for example but not limited to, wireless network, electromagnetic field), such that data and/or information (for example, electronic indications, signals) may be transmitted to and/or received from the electrical elements and/or electric circuit(s) that are electronically coupled.

A coupled inductors transformer is a type of transformer that uses approximately parallel terminals to transfer energy from one circuit to another. Each terminal functions as an inductor and the terminals are arranged in such a way that the magnetic field produced by one inductor is coupled to the magnetic field produced by the other one or more inductors. This coupling allows energy to be transferred among the terminals. Each such metallic inductor is insulated from the next one by a dielectric layer.

Coupled inductors transformers may be used in high-frequency applications where the size and weight of a conventional transformer would be impractical or inhibitive. They may also be used in applications where there is a need for isolation between multiple circuits such as a primary circuit and a secondary circuit. The coupled inductors transformers may also be smaller in dimensions and have lighter weights than conventional transformers. Among other reasons, this may be because the parallel inductors do not require a core, which is a large and heavy component in conventional transformers.

Therefore coupled inductors transformers may be used in various applications where for example there is a need to transfer energy between circuits in a small, lightweight, and efficient way. For example, coupled inductors transformers may be used in various circuitries such as radio transmitter and/or receiver, amplifier, mixer, filter, power combiner/splitter, etc. circuits of power supplies, radio frequency systems, control systems, medical equipment, telecommunications equipment, etc. The coupled inductors transformers may be implanted using various integrated circuit fabrication technologies such as three-dimensional integrated circuit fabrication.

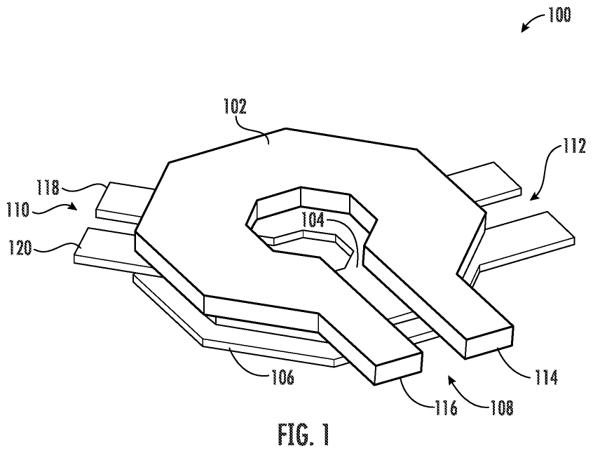

Referring now to FIG. 1, a schematic diagram illustrating a coupled inductors transformer 100 is provided. A coupled inductors transformers may include two or more terminals, for example terminal 102, terminal 104, and terminal 106. Each terminal may have a port, for example terminal 102 may have a port 108, terminal 104 may have a port 110, and terminal 106 may have a port 112.

In various embodiments the coupled inductors transformers may include one or more inputs and one or more outputs. For example, a coupled inductors transformer may function as a power combining device having for example multiple inputs and one output. When the coupled inductors transformers functions as a combiner, two or more ports may be configured as an input and at least one port may be configured as an output. In example embodiments, the coupled inductors transformers may provide a power splitting device having for example one input and multiple outputs. When the coupled inductors transformers functions as a splitter, one port of the coupled inductors transformers may be configured as input and two or more ports may be configured as output.

The coupled inductors transformers may be passive and/or reciprocal transformers. For example, the magnetic coupling between the terminals of the coupled inductors transformers provide the power transfer between one or more input ports and one or more output ports in a passive and/or reciprocal fashion. In some examples, various ports of the coupled inductors transformers may be used as either input(s) and/or output(s).

The coupled inductors transformers may also provide for efficient transfer of signals to/from various parts of the circuit. For example by providing impedance matching among various circuits, the coupled inductors transformers may efficiently transfer signal power from one circuit to another.

In example embodiments, the coupled inductors transformers may simultaneously provide any of combining and/or splitting signal powers, impedance matching for improved power transfer, and/or any other function of the coupled inductors transformers. For example, multiple circuits such as amplifier circuits may be coupled to each other in parallel to provide power to a next circuit such as an antenna. In example embodiments, a coupled inductors transformer having multiple inputs and a single output may simultaneously combine the signal powers from the amplifiers and match the output impedance with the input impedance of the antenna.

In some examples, a port of a terminal may include two pins. For example, port 108 may include pin 114 and pin 116 and the port 110 may include the pin 118 and pin 120. Similarly the port 112 may include two pins.

A signal on any of the ports may be single-ended or differential. For example, in a single-ended signal on a port, the signal on one pin of a port (for example pin 114) is measured with reference to a common ground where the other pin of the port (for example pin 116) is directly connected to. And for example, in a differential signal on a port, the signal on one pin of the port is measured with reference to the signal on the other pin on the port, independently from the common ground. In some examples, the coupled inductors transformers may transform a single-ended signal on one port to differential signal(s) on one or more output ports and vice versa which may be referred to as a balun function.

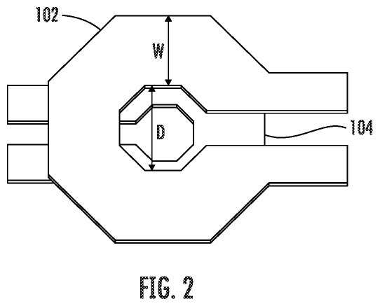

As the operational frequency increases, lower inductance values in a coupled inductors transformer are required. In order to reduce the value of inductance various sizes in the coupled inductors transformers may need to be reduced. For example, with reference to FIG. 2, an inner diameter D of one of the coupled inductors in the transformer may need to be reduced. However, reducing the size of various aspects of a coupled inductors transformers is limited by fabrication constraints. For example reducing the inner diameter D may be limited by technological design rules and a minimum distance required between the terminals during fabrication.

In order to reduce the value of inductance, another approach may be to increase the width W of the conductor paths of the inductors in the transformer, for example as shown in FIG. 2. Increasing the width W, however, may lead to an increase in the parasitic capacitance between two adjacent inductors in the transformer and may therefore degrade the performance of the coupled inductors transformers. Further, increasing W may also be limited by technological design rules and a maximum width required for the terminals during fabrication.

Various applications of coupled inductors transformers require high operation frequencies. However, as for example described above, higher operation frequencies may increase an impact of parasitic capacitances on the function of coupled inductors transformers at least in part due to the need for reduction in the dimensions of the coupled inductors transformers as the frequency increases. This may result in an increased power loss and lowered efficiency in the coupled inductors transformers.

Various embodiments of the present disclosure provide interleaved coupled inductors transformers. In accordance with example embodiments, in addition to various applications and/or advantages of coupled inductors transformers described above, the interleaved coupled inductors transformers are capable of high operation frequencies, as the impact of parasitic capacitances is reduced and higher power transfer efficiency is achieved.

For example, interleaved coupled inductors transformers with an operation frequency greater than 1 GHz are provided in various embodiments of the present disclosure. In example embodiments, the high operation frequency provides smaller dimensions for the interleaved coupled inductors transformers further facilitating their integration in an IC.

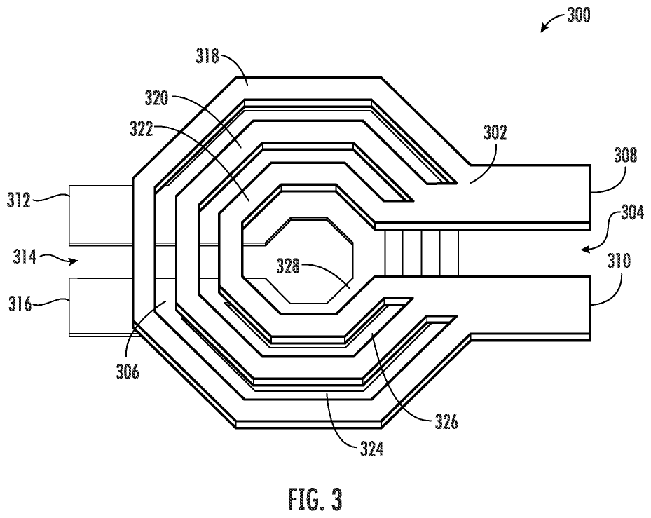

Referring now to FIG. 3, a schematic diagram illustrating an interleaved coupled inductors transformer 300 is provided in accordance with various embodiments of the present disclosure. In various embodiments, the interleaved coupled inductors transformer 300 includes a first terminal 302. In various embodiments, the first terminal 302 includes two or more branches. For example, the first terminal 302 includes a first branch of the first terminal 318, a second branch of the first terminal 320 approximately parallel to and concentric with the first branch of the first terminal 318, and a third branch of the first terminal 322 approximately parallel to and concentric with any of the first branch of the first terminal 318 and second branch of the first terminal 320. In various embodiments, the first terminal 302 may include any number of branches. For example, the first terminal 302 may include two, three, four, five, or more branches.

In various embodiments, the interleaved coupled inductors transformer 300 also includes a second terminal 306. In various embodiments, the second terminal 306 is spatially separate from the first terminal 302. The second terminal 306 may be positioned in proximity to and be approximately parallel to the first terminal 302. In example embodiments, the first terminal 302 and second terminal 306 are made using a conductive material and the space between them may be filled with a dielectric material.

In various embodiments, the second terminal 306 includes a first branch of the second terminal 324, a second branch of the second terminal 326 approximately parallel to and concentric with the first branch of the second terminal 324, and a third branch of the second terminal 328 approximately parallel to and concentric with any of the first branch of the second terminal 324 and third branch of the second terminal 328. In various embodiments, the second terminal 306 may include any number of branches. For example, the second terminal 306 may include two, three, four, or more branches. In various embodiments, the first terminal 302 has a same number of branches as the second terminal 306. In various embodiments, the first terminal 302 has a different number of branches as the second terminal 306.

In various embodiments, each terminal includes at least one port. For example, the first terminal 302 may include a first port 304, and the second terminal 306 includes a second port 314.

The example interleaved coupled inductors transformer 300, with reference to FIG. 3 is illustrated having two terminals. In various embodiments, an interleaved coupled inductors transformer may include more than two terminals. For example, an interleaved coupled inductors transformer may include three, four, five, or more terminals. The terminals may be placed adjacent to each other, for example in a stack configuration. For example, an interleaved coupled inductors transformer may have three terminals in a configuration similar to the schematic illustrated in FIG. 1. In various embodiments, each terminal of the interleaved coupled inductors transformer may have one or more terminals, and each terminal may be an input or an output of the interleaved coupled inductors transformer for example similar to what was described above with reference to FIG. 1.

In various embodiments, the branches of each terminal in the interleaved coupled inductors transformer are interleaved with branches of an adjacent terminal. For example, when observed from a view point perpendicular to any of the planes where two adjacent terminals are located, the branches of the two terminal do not overlap. For example, with reference to FIG. 3, none of the first, second, or third branches of the first terminal overlap with any of the first, second, or third branches of the second terminal. In example embodiment, such configuration reduces the parasitic capacitance of the interleaved coupled inductors transformer as the operation frequency increases and provides for a more efficient power transfer in higher frequencies. In various embodiments, the ports of a terminal may overlap the branches of the adjacent terminal in order to provide electrical coupling to the branches. In various embodiments, two ends of each branch of a terminal are electronically coupled to the port of the terminal.

In various embodiments, as for example illustrated in the schematic diagram of FIG. 3 illustrating the interleaved coupled inductors transformer 300, the branches of various terminals may be concentric. For example the first and second branches of the first terminal and the first and second branches of the second terminal may be approximately concentric.

In various embodiments, terminals and/or branches of the interleaved coupled inductors transformer may have various geomatical shapes such as partially circular, polygonal, rectangular, and/or square.

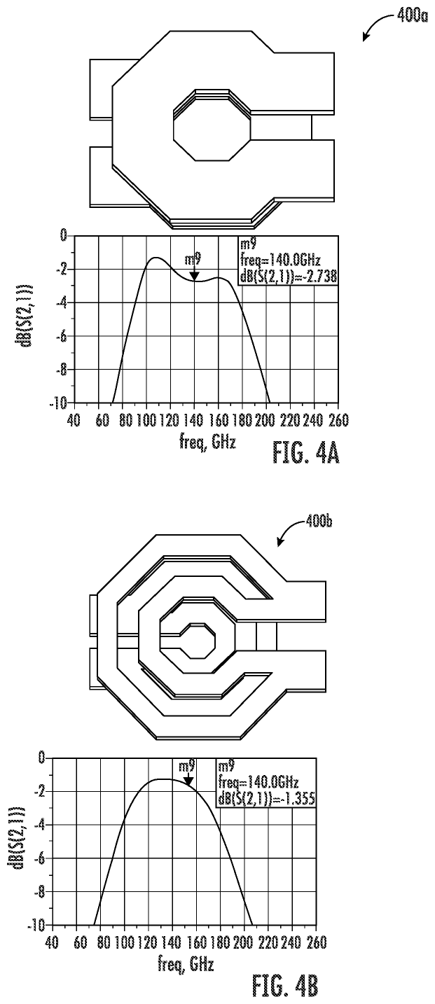

Referring now to FIG. 4A, a measured or simulated value for the frequency transfer function of a coupled inductors transformer 400a provides a loss of −2.738 dB at 140 GHz. Referring to FIG. 4B, a measured or simulated value for the frequency transfer function of an interleaved coupled inductors transformer 400b provides a loss of −1.355 dB at 140 GHz. Therefore, the measured values illustrate an improvement by 1.4 dB in power transfer efficiency at 140 GHz when using an interleaved coupled inductors transformer according to example embodiments of the present disclosure.

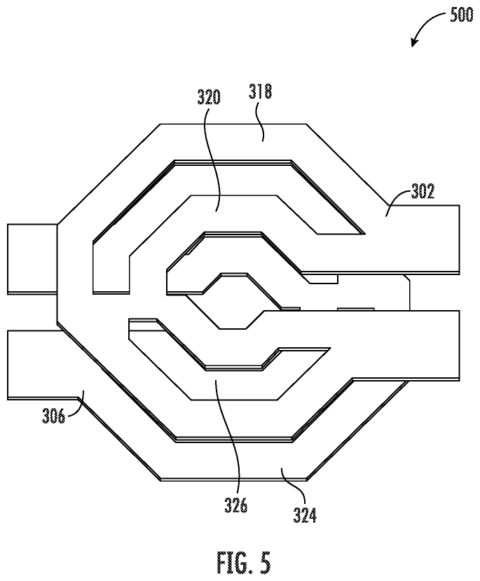

Referring now to FIG. 5, a schematic diagram illustrating an interleaved coupled inductors transformer 500 is provided in accordance with various embodiments of the present disclosure. In various embodiments, a length of the first and second branches of the first terminal is approximately equal to a length of the first and second branches of the second terminal. In various embodiments, an impedance of the first terminal 302 is approximately the same as an impedance of the second terminal 306. In various examples, any of a resistance and/or an inductance of the terminals at an operation frequency may be approximately equal.

In various embodiments, an aggregated length of the first and second branches of the first terminal is approximately equal to an aggregated length of the first and second branches of the second terminal. In various embodiments, a length of the first branch of the first terminal 318 is approximately the same as a length of the first branch of the second terminal 324, and a length of the second branch of the first terminal 320 is approximately the same as a length of the second branch of the second terminal 326.

In various embodiments, the branches of various terminals may have non overlapping centers. For example, the first and second branches of the first terminal are off centered with respect to the first and second branches of the second terminal such that a length of the first and second branches of the first terminal is approximately equal to a length of the first and second branches of the second terminal, for example as described above. In various embodiments, the first and second branches of the first terminal are off centered with respect to the first and second branches of the second terminal such that an impedance of the first terminal 302 is equal to an impedance of the second terminal 306.

In various embodiments, the branches of the terminals are positioned and/or shaped such that regardless of whether the centers of the terminals overlap or not, the branches of a terminal do not overlap with any of the branches of another terminal. In various embodiments, the overlap of the branches referred to an overlap when viewed from a specific direction, for example when viewed from above the interleaved coupled inductors transformer.

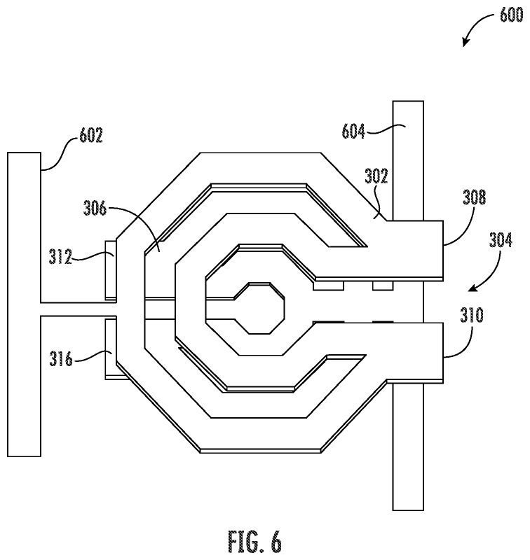

Referring now to FIG. 6, a schematic diagram illustrating an interleaved coupled inductors transformer 600 is provided in accordance with various embodiments of the present disclosure. In various embodiments, the first terminal 302 of the interleaved coupled inductors transformer 600 includes a first port 304. The first port 304 may include a first pin of the first port 308, and a second pin of the first port 310. In various embodiments, a first DC feed 602 is electronically coupled to a middle point from the first pin of the first port 308 to the second pin of the first port 310. The first DC feed 602 may be configured to provide a first bias voltage to the first terminal 302. In various embodiments, the second terminal 306 of the interleaved coupled inductors transformer 600 includes a first pin of the second port 312, a second pin of the second port 316, and a second DC feed 604 electronically coupled to a middle point from the first pin of the second port 312 to the second pin of the second port 316. In various embodiments, the second DC feed 604 is configured to provide a second bias voltage to the second terminal 306.

In various embodiments, branches of each terminal of the interleaved coupled inductors transformer may be in a same plane corresponding to the terminal. Various planes corresponding to various terminals may be approximately parallel to each other for example in a stacked configuration. For example, the first and second branches of the first terminal of an interleaved coupled inductors transformer are in a same first plane and the first and second branches of the second terminal are in a same second plane. The first and second plane may be approximately parallel to each other.

In various embodiments, branches of a terminal may be in different planes. Various planes corresponding to various branches may be approximately parallel to each other. For example, each of the first and second branches of the first terminal and each of the first and second branches of the second terminal are in a different corresponding plane.

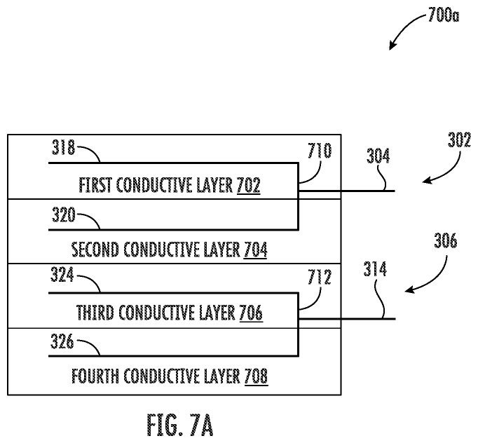

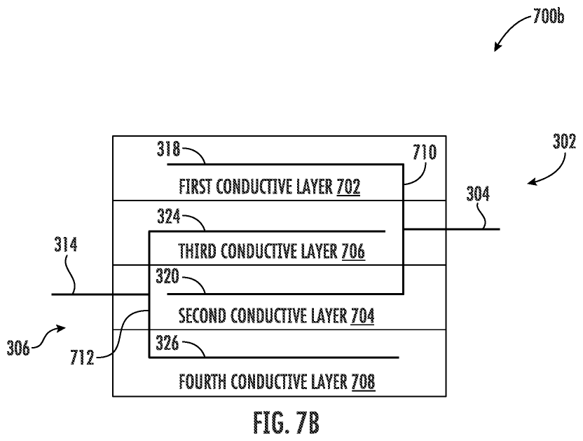

Referring to FIG. 7A, a schematic diagram illustrating an interleaved coupled inductors transformer 700a is provided in accordance with various embodiments of the present disclosure. The interleaved coupled inductors transformer 700a may be fabricated using various conductive layers of a three-dimensional integrated circuit.

In various embodiments, various branches of a terminal are made from one or more conductive layers of a three-dimensional integrated circuit. For example, the first and second branches of the first terminal are made using a first conductive layer of a three-dimensional integrated circuit and the first and second branches of the second terminal are made using a second conductive layer of a second conductive layer of the three-dimensional integrated circuit (not shown).

In various embodiments, the first branch of the first terminal 318 is made using a first conductive layer 702 of a three-dimensional integrated circuit and the second branch of the first terminal 320 is made using a second conductive layer 704 of the three-dimensional integrated circuit. In various embodiments, the first branch of the second terminal 324 is made using a third conductive layer 706 of the three-dimensional integrated circuit and the second branch of the second terminal 326 is made using a fourth conductive layer 708 of the three-dimensional integrated circuit.

In various embodiments, the first conductive layer 702 and the second conductive layer 704 of the three-dimensional integrated circuit are electrically coupled by a first via 710. The first via 710 may electronically couple the first branch of the first terminal 318 with the second branch of the first terminal 320 and the first port 304. In various embodiments, the third conductive layer 706 and the fourth conductive layer 708 of the three-dimensional integrated circuit are electrically coupled by a second via 712. The second via 712 may electronically couple the first branch of the second terminal 324 with the second branch of the second terminal 326 and the second port 314.

In various embodiments, the first conductive layer 702 and the second conductive layer 704 are both positioned in a same side of the second conductive layer 704 and the third conductive layer 706. For example the first conductive layer 702, second conductive layer 704, third conductive layer 706, and fourth conductive layer 708 may be stacked as illustrated in FIG. 7A.

Referring now to FIG. 7B, a schematic diagram illustrating an interleaved coupled inductors transformer 700b is provided in accordance with various embodiments of the present disclosure. In various embodiments, the first branch of the first terminal 318 is made using a first conductive layer 702 of a three-dimensional integrated circuit and the second branch of the first terminal 320 is made using a second conductive layer 704 of the three-dimensional integrated circuit. In various embodiments, the first branch of the second terminal 324 is made using a third conductive layer 706 of the three-dimensional integrated circuit and the second branch of the second terminal 326 is made using a fourth conductive layer 708 of the three-dimensional integrated circuit.

In various embodiments, the first conductive layer 702 and the second conductive layer 704 of the three-dimensional integrated circuit are electrically coupled by a first via 710. The first via 710 may electronically couple the first branch of the first terminal 318 with the second branch of the first terminal 320 and the first port 304. In various embodiments, the third conductive layer 706 and the fourth conductive layer 708 of the three-dimensional integrated circuit are electrically coupled by a second via 712. The second via 712 may electronically couple the first branch of the second terminal 324 with the second branch of the second terminal 326 and the second port 314.

In various embodiments, the inductive layers may be interleaved with each other in various forms. For example, the third conductive layer 706 is sandwiched between the first and second conductive layers 704 and the second conductive layer 704 is sandwiched between the third and fourth conductive layers 708. For example the first conductive layer 702, second conductive layer 704, third conductive layer 706, and fourth conductive layer 708 may be stacked as illustrated in FIG. 7B.

Referring to FIG. 7A and FIG. 7B, in various embodiments, different conductive layers may have similar or different thicknesses. FIG. 7A and FIG. 7B illustrate example embodiments on an interleaved coupled inductors transformer having two terminals each having two branches. In various embodiments, interleaved coupled inductors transformer having any number of terminals where each terminal has any number of branches may be implemented using various inductive layers in a three-dimensional integrated circuit. In various embodiments, any of the conductive layers may be electronically insulated from a neighboring conductive layer using a dielectric layer (not shown).

In example embodiments, any of the conductive layers described above may be made from metal. For example, the conductive layers may be made from any of Copper (Cu), Aluminum (Al), Tungsten (W), Gold (Au), etc., in Integrated Silicon technologies or made from any of Copper, Gold, or any other metallic alloys in printed circuit boards (PCBs). In example embodiments, the vias may be made from any of the conductive materials described above. For example, the vias may be made from any of Copper (Cu), Aluminum (Al), Tungsten (W), Gold (Au), etc., in Integrated Silicon technologies or made from any of Copper, Gold, or any other metallic alloys in printed circuit boards (PCBs). In example embodiments, the vias may be made from the same material as the conductive layer(s).

In example embodiments, any of the dielectric layers described above may be made from Silicon dioxides (SiO2) in Integrated Silicon technologies or made from any of Alumina, Teflon, Ceramic, Polyimide, etc., in PCBs.

In example embodiments, in Integrated Silicon technologies, any of the conductive and/or dielectric layers may have a thickness from approximately 100 nm to a few μm (for example to a range between approximately 1 μm to approximately 10 μm). In example embodiments, in PCB technologies, any of the conductive and/or dielectric layers may have a thickness from approximately a few μm (for example from a range between approximately 1 μm to approximately 10 μm) to a few mm (for example to a range between approximately 1 mm to approximately 10 mm).

The schematic diagrams shown in various figures herein illustrate two terminals as example purposes. In various embodiments, an interleaved coupled inductors transformer may include any two or more number of terminals and a terminal may include any number of branches having any of the features described herein. For example, in various embodiments the branches of a third terminal may be non-overlapping with the branches of all or any of the other terminals.

Many modifications and other embodiments of the disclosures set forth herein will come to mind to one skilled in the art to which these disclosures pertain having the benefit of teachings presented in the foregoing descriptions and the associated drawings. Although the figures only show certain components of the apparatus and systems described herein, it is understood that various other components may be used in conjunction with the system. Therefore, it is to be understood that the disclosures are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. The disclosed embodiments relate primarily to interleaved coupled inductors transformers, one skilled in the art may recognize that such principles may be applied to any transformer device. Alternative embodiments that result from combining, integrating, and/or omitting features of the embodiment(s) are also within the scope of the disclosure. Accordingly, the scope of protection is not limited by the description set out above.

Additionally, the section headings used herein are provided for consistency with the suggestions under 37 C.F.R. 1.77 or to otherwise provide organizational cues. These headings shall not limit or characterize the disclosure(s) set out in any claims that may issue from this disclosure.

Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

What is claimed is:

1. An interleaved coupled inductors transformer comprising:
a first terminal comprising:
a first port;
a first branch of the first terminal; and
a second branch of the first terminal approximately parallel to and concentric with the first branch of the first terminal; and
a second terminal spatially separate from the first terminal, the second terminal comprising:
a second port;
a first branch of the second terminal;
a second branch of the second terminal approximately parallel to and concentric with the first branch of the second terminal, wherein the first and second branches of the first terminal do not overlap with the first and second branches of the second terminal.

2. The interleaved coupled inductors transformer of claim 1, wherein the first and second branches of the first terminal are in a same first plane and the first and second branches of the second terminal are in a same second plane.

3. The interleaved coupled inductors transformer of claim 2, wherein the first and second branches of the first terminal are made using a first conductive layer of a three-dimensional integrated circuit and the first and second branches of the second terminal are made using a second conductive layer of the three-dimensional integrated circuit.

4. The interleaved coupled inductors transformer of claim 1, wherein each of the first and second branches of the first terminal and the first and second branches of the second terminal are in a different corresponding plane.

5. The interleaved coupled inductors transformer of claim 4, wherein the first branch of the first terminal is made using a first conductive layer of a three-dimensional integrated circuit and the second branch of the first terminal is made using a second conductive layer of the three-dimensional integrated circuit, or wherein the first branch of the second terminal is made using a third conductive layer of the three-dimensional integrated circuit and the second branch of the second terminal is made using a fourth conductive layer of the three-dimensional integrated circuit.

6. The interleaved coupled inductors transformer of claim 5, wherein the first conductive layer and the second conductive layer of the three-dimensional integrated circuit are electrically coupled by a first via or the third conductive layer and the fourth conductive layer of the three-dimensional integrated circuit are electrically coupled by a second via.

7. The interleaved coupled inductors transformer of claim 5, wherein the first conductive layer and the second conductive layer are both positioned in a same side of the second conductive layer and the third conductive layer.

8. The interleaved coupled inductors transformer of claim 5, wherein the third conductive layer is sandwiched between the first and second conductive layers and the second conductive layer is sandwiched between the third and fourth conductive layers.

9. The interleaved coupled inductors transformer of claim 1, wherein a length of the first and second branches of the first terminal is approximately equal to a length of the first and second branches of the second terminal or an impedance of the first terminal is approximately the same as an impedance of the second terminal.

10. The interleaved coupled inductors transformer of claim 1, wherein the first and second branches of the first terminal and the first and second branches of the second terminal are approximately concentric.

11. The interleaved coupled inductors transformer of claim 1, wherein:
the first terminal comprising:
a first pin of the first port;
a second pin of the first port; and
a first DC feed electronically coupled to a middle point from the first pin of the first port to the second pin of the first port, the first DC feed configured to provide a first bias voltage to the first terminal; or
the second terminal comprising:
a first pin of the second port;
a second pin of the second port; and
a second DC feed electronically coupled to a middle point from the first pin of the second port to the second pin of the second port, the second DC feed configured to provide a second bias voltage to the second terminal.

12. The interleaved coupled inductors transformer of claim 1, wherein:
the first terminal comprising at least a third branch of the first terminal approximately parallel to and concentric with the first branch of the first terminal and with the second branch of the first terminal; and
the second terminal comprising at least a third branch of the second terminal approximately parallel to and concentric with the first branch of the second terminal and with the second branch of the second terminal, wherein the first, second, and the at least third branches of the first terminal do not overlap with the first, second, and the at least third branches of the second terminal.

13. The interleaved coupled inductors transformer of claim 1 comprising:
at least a third terminal spatially separate from the first terminal and the second terminal, the at least third terminal comprising:
a third port;
a first branch of the at least third terminal;
a second branch of the at least third terminal approximately parallel to and concentric with the first branch of the at least third terminal, wherein the first and second branches of the at least third terminal do not overlap with the first and second branches of the first terminal or with the first and second branches of the second terminal.

14. An interleaved coupled inductors transformer comprising:
a first terminal comprising:
a first port;
a first branch of the first terminal; and
a second branch of the first terminal; and
a second terminal spatially separate from the first terminal, the second terminal comprising:
a second port;
a first branch of the second terminal;
a second branch of the second terminal, wherein the first and second branches of the first terminal do not overlap with the first and second branches of the second terminal, and wherein the first and second branches of the first terminal are concentric with the first and second branches of the second terminal.

15. An interleaved coupled inductors transformer comprising:
a first terminal comprising:
a first port;
a first branch of the first terminal; and
a second branch of the first terminal; and
a second terminal spatially separate from the first terminal, the second terminal comprising:
a second port;
a first branch of the second terminal;
a second branch of the second terminal, wherein the first and second branches of the first terminal do not overlap with the first and second branches of the second terminal, and wherein the first and second branches of the first terminal are off centered with respect to the first and second branches of the second terminal such that an impedance of the first terminal is equal to an impedance of the second terminal.

16. The interleaved coupled inductors transformer of claim 15, wherein the first and second branches of the first terminal are in a same first plane and the first and second branches of the second terminal are in a same second plane and wherein the first and second branches of the first terminal are made using a first conductive layer of a three-dimensional integrated circuit and the first and second branches of the second terminal are made using a second conductive layer of a second conductive layer of the three-dimensional integrated circuit.

17. The interleaved coupled inductors transformer of claim 15, wherein each of the first and second branches of the first terminal and the first and second branches of the second terminal are in a different corresponding plane and wherein the first branch of the first terminal is made using a first conductive layer of a three-dimensional integrated circuit and the second branch of the first terminal is made using a second conductive layer of the three-dimensional integrated circuit, or wherein the first branch of the second terminal is made using a third conductive layer of the three-dimensional integrated circuit and the second branch of the second terminal is made using a fourth conductive layer of the three-dimensional integrated circuit.

18. The interleaved coupled inductors transformer of claim 17, wherein the first conductive layer and the second conductive layer are both positioned in a same side of the second conductive layer and the third conductive layer.

19. The interleaved coupled inductors transformer of claim 17, wherein the third conductive layer is sandwiched between the first and second conductive layers and the second conductive layer is sandwiched between the third and fourth conductive layers.

20. The interleaved coupled inductors transformer of claim 15, wherein:
the first terminal comprising:
a first pin of the first port;
a second pin of the first port; and
a first DC feed electronically coupled to a middle point from the first pin of the first port to the second pin of the first port, the first DC feed configured to provide a first bias voltage to the first terminal; or
the second terminal comprising:
a first pin of the second port;
a second pin of the second port; and
a second DC feed electronically coupled to a middle point from the first pin of the second port to the second pin of the second port, the second DC feed configured to provide a second bias voltage to the second terminal.
